(19) United States
(12) Patent Application Publication
(10) Pub. No.: US 2006/0031326 A1
(43) Pub. Date: Feb. 9, 2006

(54) Managing personal communications from a calendar scheduling application

(76) Inventor: Francis Ovenden, Groton, MA (US)

Correspondence Address: STEUBING MCGUINNESS & MANARAS LLP, 125 NAGOG PARK, ACTON, MA, 01720, US

(21) Appl. No.: 10/885,351

(22) Filed: Jul. 6, 2004

(51) Int. Cl. G06F 15/16

(52) U.S. Cl. 709/206; 709/207

(57) ABSTRACT

Triggering events in an electronic calendar schedule prompt modifications to responses to incoming communications. Different types of triggering events prompt different response modifications to different types of incoming communications. Response modifications may include setting a temporary voice greeting during a meeting scheduled in the calendar, and temporarily suspending an instant messaging session. Similarly, call redirection, out-of-office email alerts, and remote notification may be set during a business trip scheduled in the calendar. Other response modifications may be based on date, day of the week, and time of day.

### FIELD OF THE INVENTION

The present invention relates generally to communications technology, and more specifically to use of a calendar scheduling application to facilitate management of personal communications.

### BACKGROUND OF THE INVENTION

It is now common for a person to use multiple communications tools such as a mobile telephone, PDA, personal computer, voice mail, email, and instant messaging. The proliferation of communications tools has created a need to manage them. For example, it is not desirable to create a situation where a person repeatedly attempts to contact another person through various different tools without success. Similarly, it is sometimes undesirable to be interrupted during a scheduled event. Out of office email response messages, temporary voice messages and call forwarding are known technologies for handling communications when the intended receiver is unavailable or does not wish to be interrupted. However, configuration and management of these technologies can be a nuisance. In particular, each tool must be individually, manually configured each time a change is desired in the manner in which communications are handled. This is at best an inconvenience, such as for relatively long events such as business trips or vacation, and at worst impractical.

### SUMMARY OF THE INVENTION

In accordance with the present invention, a calendar schedule is employed by a communications controller application to select and implement responses to incoming communications. In particular, the communications controller application searches a user's electronic schedule for a triggering event and, proximate with the start of the triggering event, signals one or more communications services devices associated with the user's communication tools in order to modify their responses to incoming communications. Triggering events include scheduled events such as meetings, business trips and vacation, and non-scheduled events such as a particular date, day of the week and time of the day. Communications services devices that may be signaled include, but are not limited to, voice mail servers, email servers, traditional or Internet Protocol (IP) Private Branch Exchanges (“PBXs”), enhanced call management servers, and Instant Messaging “IM” servers. Response modifications may include, but are not limited to, setting a temporary voicemail greeting, redirecting voice calls, setting an email alert reflector, and suspending an instant messaging session.

The communications services devices may be signaled to provide specific modifications according to a template selected from a plurality of templates created for particular types of triggering events. Selection of the response template is based on information in the electronic calendar associated with the triggering event. For example, the status of the user during the event may be characterized in the calendar by the user as either “busy” or “out of office” in accordance with the widely used application known as Microsoft Outlook. A template associated with “busy” status might, for example, suspend instant messaging sessions and implement a temporary voicemail greeting, whereas a template associated with “out of office” status would also set an out-of-office email alert. A third template might be employed outside of regular office hours. For example, the out-of-office-hours template might set a temporary voicemail greeting indicating that the user is not in the office, or perhaps that the user is only available during regular office hours. Alternatively, the out-of-office-hours template might redirect incoming voice calls to an alternate phone, such as a mobile phone. Further, the calendar entry may be parsed for keywords or codes associated with particular templates in order to facilitate template selection. Templates may also be selected based on date, day of the week and time of day.

One advantage of the invention is reduction of the effort normally required to reprogram responses for multiple communications tools. Prior to the present invention, each tool was separately and manually configured. For example, a telephone handset could be used to manually set a new voicemail message or cause calls to be redirected, and an email program could be used to manually program an email server to send out-of-office alerts. However, the present invention enables a single calendar entry to prompt automated reprogramming of responses to incoming voice, email and instant message communications. Further, the templates may be employed to automate response changes for various different types of triggering events and situations. Consequently, the present invention facilitates increased productivity.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram of a network architecture including apparatus for managing communications based on an electronic calendar schedule.

FIG. 2 illustrates a method of managing communications with a communications controller application based on a calendar schedule.

FIG. 3 illustrates response templates employed by the communications controller application.

### DETAILED DESCRIPTION OF EXEMPLARY EMBODIMENTS

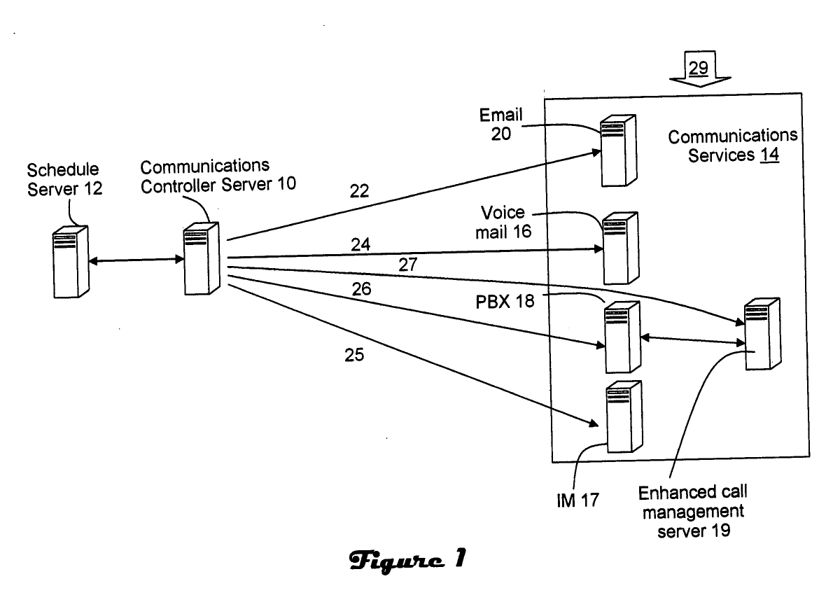

Referring to FIG. 1, a communications controller server 10 is employed in conjunction with a schedule server 12 for managing communications. The communications controller server is in communication with the schedule server 12 and communications services controlling apparatus 14 such as a voice mail server 16, a traditional or Internet Protocol (IP) Private Branch Exchange (“PBX”) 18 and associated enhanced call management server 19, an email server 20 and IM server 17. Each communications service apparatus may be associated with an individual management interface 22, 24, 25, 26, 27 operative to enable communication between the communications controller server and the respective communications service apparatus. The schedule server 12 includes an electronic calendar 30 for scheduling events. The email server 20 is operative to manage sending, receiving and storage or email for multiple users. The PBX 18 is operative to manage outgoing and incoming voice/phone communications for multiple users. The enhanced call management server 19 is operative to augment the capabilities of the PBX with rule-based call redirect functions, filtering, and other features. The voicemail server 16 is operative to record, save and present various voice messages for particular types of incoming calls, and store messages made by callers for subsequent playback to users. It should be noted that the calendar schedule server 12 functions may be bundled with the email server 20 functions, such as is done with MS Outlook. It should also be noted that the communications controller server 10 functions could be integrated with and executed on the schedule server 12 or some other device, including communications service devices 14. In general the invention is open to flexible system partitioning facilitating many different product formats.

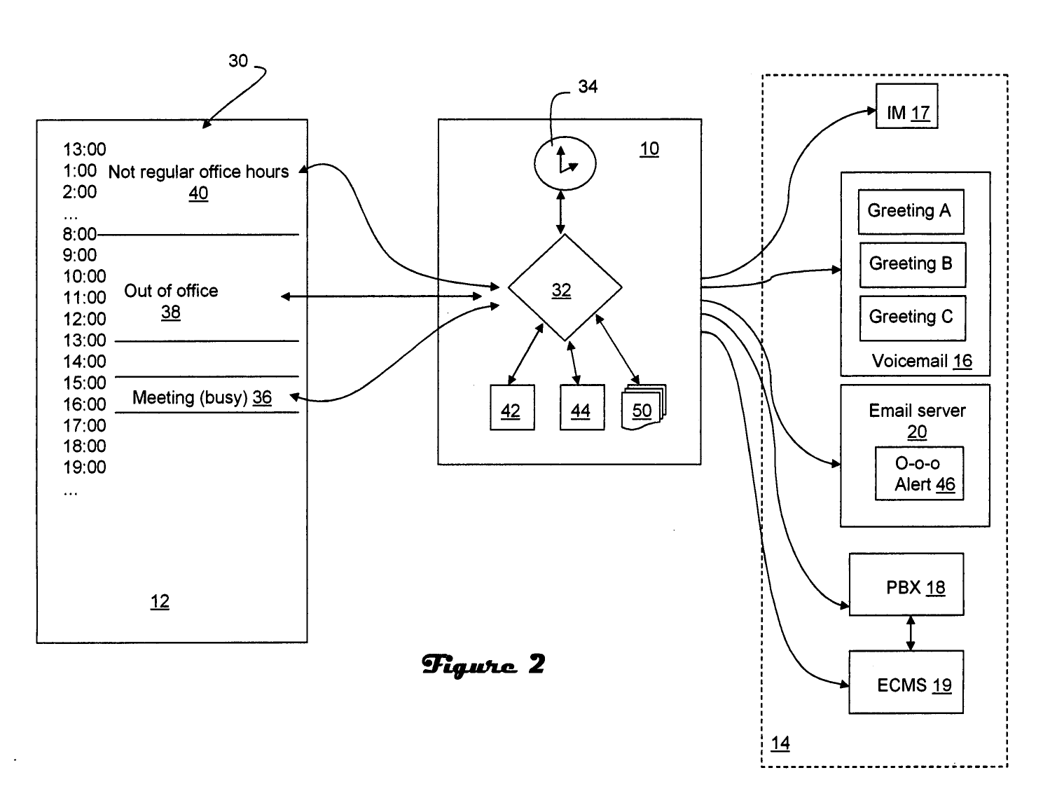

Referring to FIGS. 1 and 2, the communications controller server 10 includes a communications controller application 32 for communicating messages and control signals over each management interface based on triggering events which are detected in a user's calendar schedule 30 in the schedule server or otherwise. Triggering events may be any of scheduled events, date, time of day, or day of the week. Date, time of day and day of week triggering events may be initiated based on information in the communications controller server and an internal clock 34, or the user's schedule 30. The communications controller application 32 continuously or periodically parses the user's schedule 30 for triggering events and, proximate to the start time of a triggering event, the communications controller application signals to selected communications service devices 14 via the associated management interfaces to reprogram those devices to modify their responses to incoming communications.

One response modification that may be implemented is setting a temporary voicemail greeting. In response to a triggering event such as a meeting 36 where the event indicates that the user is “busy,” or an event 38 indicating that the user is “out of office,” or outside of normal working hours 40, the communications controller application 32 automatically re-programs the user's voicemail greeting. This may be accomplished by selecting one of a plurality of pre-existing voice greetings stored by the voicemail server 16, e.g., Greeting B, for use in lieu of the normal greeting, e.g., Greeting A. Similarly, if there are multiple normal greetings, such as internal and external greetings, one or both of those greetings may be changed. To put the greeting selection in context, a greeting stating “I'm in a meeting now” might be selected for the “busy” case 36, a greeting stating “I'm out of the office” might be selected for the “out of office” case 38, and a greeting stating “I can normally be contacted Monday through Friday between 8 AM and 5:30 PM” might be selected for case 40. Once the appropriate greeting is selected, the communications controller application 32 signals the voice mail server 16, thereby reprogramming the voice mail server to implement the selected greeting. The communications controller application may signal the voicemail server again to restore the usual greeting after the triggering event has ended. Alternatively, the voicemail server may be initially reprogrammed proximate to the start of the triggering event to employ the selected greeting for a predetermined period of time and then restore the usual greeting.

The communications controller application may also be employed to change the voicemail greeting daily, such as by adding the current date, without user intervention. In one embodiment, the communications controller application is implemented with a capability to piece together complete verbal messages from a database 42 of audio fragments. For instance, the user might be asked for voice samples of the days of the week, months, and other necessary words and phrases to construct greetings automatically. Alternatively the user could select a computer synthesized voice from a synthesizer 44, potentially generating greetings as text that is transformed to speech automatically.

Another response modification is setting an email reflector or out-of-office alert. For example, during periods of travel when email will not be checked or only intermittently checked as indicated by the “out of office” case 38, a temporary alert such as an “out-of-office alert” 46 for email is selected via the email server 20 and set on behalf of the user. In particular, the communications controller application automatically reprograms the email server via the management interface proximate to the start of the triggering event to cause the email server to send an email reply to incoming emails indicating the user is currently out of the office. As with the voice greeting example above, the communications controller application may signal the email server proximate to the end of the triggering event in order to cease the out of office alert or initially program the email server to send the out of office alerts for the duration of the triggering event, depending on the capabilities of the email server.

Another response modification is call redirection. For example, during periods of travel as indicated by the “out of office” case or outside of normal working hours it may be desirable to have calls redirected to another phone, such as a mobile phone. Enhanced call management servers and some PBXs have call redirect capability. Hence, a triggering event may be used by the communications controller application to prompt reprogramming of the PBX 18 or enhanced call management server 19 to cause call redirection. Further, the reprogramming can be employed to take advantage of other functions provided by the enhanced call management server such as filtering the calls which are redirected, i.e., only redirecting calls from specific callers to the mobile phone.

Another response modification is suspending instant messaging (“IM”) availability. Instant message availability, i.e., state, may be changed in response to triggering events such as the “busy” and “out of office” cases 36, 38, and outside of normal working hours 40. For example, the communications controller application 32 may intercept the users client session or log the user out by effectively logging the user in a second time “at another location” and hence stealing the user's session for the duration of the triggering event. Those skilled in the art will recognize that there are a variety of methods for implementing agent, control of instant messaging to achieve the goal of manipulating the users IM availability.

Another response modification is remote notification. Remote notification may be initiated by a triggering event to notify the user on a portable device about messages received and calls redirected. Remote notification may include use of SMS text messages, instant messages, email messages, or any other supported messaging system available from the users communications devices and services, that can be received silently and enable the user to have visibility of communications activity. A communications log may also be generated and made available from a personal user web page.

The start, stop and duration of the response modification may differ from that of the triggering event. For example, response modification may be implemented a selected number of minutes prior to the start of the triggering event in order to avoid beginning a communication likely to extend into the start of the triggering event. Similarly, usual responses may be restored a selected number of minutes before or after the end of a triggering event. Alternatively, the user may be prompted by the communications controller application for verification that the usual responses should be restored. Alternatively, communication tool activity may be monitored and the usual responses restored when a determination is made that the triggering event has ended, regardless of the scheduled end time, e.g., sense that a telephone meeting has ended when the call is disconnected and automatically restore normal responses.

Response modifications may also be customized with details of the triggering event. For example, the communications controller application may modify the “I'm in a meeting” temporary voicemail greeting described above with the message generation capabilities described above to generate a temporary voicemail greeting indicating “I'm in a meeting until 4 PM.” Similarly, the out of office email alert may be modified to indicate the date of expected return to the office based on the end of the triggering event in the calendar.

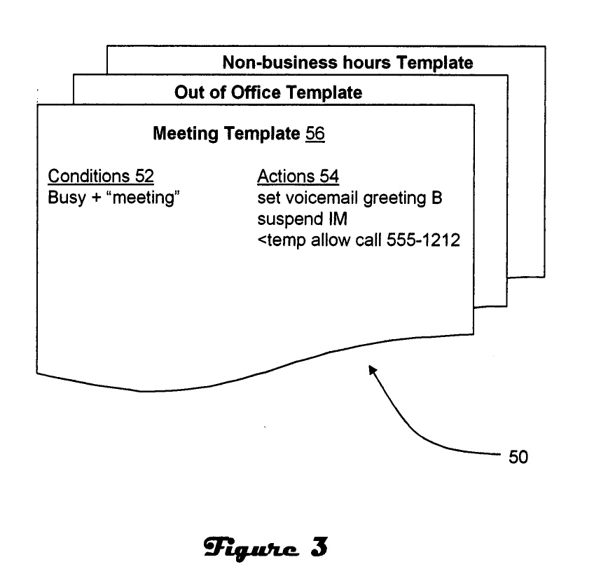

Referring now to FIGS. 2 and 3, bindings between triggering event types and response modifications may be organized into templates 50. Each template includes data indicating the type of triggering event (conditions 52) for which the template should be selected, such as the “busy” and “out of office” indicators, and keywords or codes detected in the calendar. Further, each template includes data (actions 54) indicating which communications services devices are to be signaled and the manner in which responses are to be modified. Proximate to the start of the triggering event, the communications controller application selects one of the templates based on the triggering event type data and signals the communications services devices listed in that template to cause the indicated response modifications. For example, a meeting template 56 may be associated with the “busy” case described above (or alternatively associated with both the “busy” indicator and the keyword “meeting” in the triggering event entry). The meeting template includes data for setting a temporary voicemail greeting that indicates “I'm in a meeting now.” Further, the meeting template includes data for suspending active IM sessions. Templates for out of office on business, out of office on vacation and out of office outside normal working hours may also be employed.

A setup wizard may be employed to facilitate setup of the communications controller application for an individual user. For example, the setup wizard could prompt the user to identify, or automatically scan the network for, communications services devices. The identified communications services devices could then be associated with default response modifications and templates. The user might be provided an opportunity to modify the default responses and templates in order to create customized responses and templates. For example, a default response could be that a temporary voicemail greeting indicating “I'm in a meeting” is set when the triggering event is the “busy” case, and a normal default response could be to ring then forward to voicemail on no reply. The user might modify the default to indicate “I'm in a meeting” only when both the “busy” indicator is set and the keyword “meeting” is present in the subject line of the calendar entry.

Temporary or one-time modifications to templates may be implemented to accommodate less frequent types of triggering events. In particular, override condition response modifications may be overlaid on templates without permanently modifying the template. One example of an override condition is avoiding or delaying setting the temporary voicemail greeting. For example, if a user is in a meeting waiting for another person to call the user to be conferenced-in to the meeting, the user may wish for incoming calls to ring-through during the event so that the expected incoming call is not missed. Consequently, the schedule controller application may provide means for overlaying templates such as the meeting template with modifications that do not permanently modify the template. In the example, the features of the enhanced call management server could be employed to ring-through only the call from the expected caller during the meeting, and direct all other incoming calls to the temporary voicemail greeting specified by the template.

It should be noted that communications controller application functions can be integrated with related advanced communications agent functions that are not directly part of the invention. For example, web based remote access for email and voicemail retrieval, one voice mailbox, advanced call routing, etc. Further, a user profile may be generated and maintained to facilitate operations that will be executed repeatedly. The user profile may include the templates and also actions to be performed based on time of day, day of week, etc., unless overridden by a scheduled event in the calendar. Calendar events might similarly have default actions if there are no explicit overriding instructions provided. For example, if an appointment is defined as out-of-office then the user may specify a default general out-of-office voice greeting and out-of-office email alert be applied. In this way the manager may be changing messages and call redirection settings without the user taking any explicit actions.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. It should be noted that the invention describes management of common communication services but it may also be implemented to manage other and future types of communication services. Accordingly, the invention should not be viewed as limited except by the scope and spirit of the appended claims.

What is claimed is:

1. A communications controller application operative in conjunction with a calendar schedule and at least one communications device associated with a communications service controlling device comprising:
program logic operative to query the calendar schedule to identify a triggering event;
program logic operative to select a response to incoming communications based at least in-part on the identified triggering event; and
signaling logic operative to prompt the communications service controlling device to implement the selected response.

2. The communications controller application of claim 1 wherein the triggering event is selected from the group consisting of: a scheduled calendar event, date, day of the week, and time of day.

3. The communications controller application of claim 1 wherein selected response implementation occurs before the start of the triggering event.

4. The communications controller application of claim 1 wherein the selected response includes at least one action selected from the group consisting of: forwarding a voice call to an alternate device; changing a voicemail greeting; suspending an instant messaging session; setting an email alert; and providing remote notification.

5. The communications controller application of claim 1 further including program logic operative to scan a triggering event for predetermined keywords or codes for use in response selection.

6. The communications controller application of claim 1 further including a plurality of pre-existing response templates binding triggering event types with responses.

7. The communications controller application of claim 6 further including program logic for overlaying a selected template with a response modification without persistently modifying the template.

8. The communications controller application of claim 1 further including an audio message assembler operative of generate at least a portion of a voicemail greeting from a plurality of audio fragments.

9. The communications controller application of claim 1 further including monitoring logic operative to rescind the selected response when the end of the triggering event is detected based on communications device operation.

10. A method for controlling communications in conjunction with a calendar schedule and at least one communications device associated with a communications service controlling device comprising the steps of:
querying the calendar schedule to identify a triggering event;
selecting a response to incoming communications based at least in-part on the identified triggering event; and
signaling the communications service controlling device to implement the selected response.

11. The method of claim 10 wherein the triggering event is selected from the group consisting of: a scheduled calendar event, date, day of the week, and time of day.

12. The method of claim 10 including the further step of implementing the selected response before the start of the triggering event.

13. The method of claim 10 wherein the step of selecting a response includes at least one action selected from the group consisting of: forwarding a voice call to an alternate device; changing a voicemail greeting; suspending an instant messaging session; setting an email alert; and providing remote notification.

14. The method of claim 10 further including the step of scanning a triggering event for predetermined keywords or codes for use in selecting a response.

15. The method of claim 10 further including a plurality of pre-existing response templates binding triggering event types with responses.

16. The method of claim 15 further including the step of overlaying a selected template with a response modification without persistently modifying the template.

17. The method of claim 10 further including the step of generating at least a portion of a voicemail greeting from a plurality of audio fragments.

18. The method of claim 1 further including the step of rescinding the selected response when the end of the triggering event is detected based on communications device operation.
